(19) United States
(12) Patent Application Publication
(10) Pub. No.: US 2005/0127173 A1
(43) Pub. Date: Jun. 16, 2005

(54) Point of sale automated testing technology (POSATT©)

(76) Inventor: Charles W. Idol JR., Hagerstown, MD (US)

Correspondence Address: Charles Idol Jr., P.O. Box 2172, Hagerstown, MD, 21742, US

(21) Appl. No.: 10/734,899

(22) Filed: Dec. 15, 2003

(51) Int. Cl. G06K 15/00

(52) U.S. Cl. 235/383

(57) ABSTRACT

The invention is a solution that is architected to simulate POS with transactions that allows businesses to test the POS transactions in a defined and repeatable manner. This invention provides a software solution and method to test point of sale test transactions and validate that the correct point of sale transactions and discounts have passed quality assurance policy and standards and ready to be deployed to the production environment. The solution captures, for re-use, the systemic responses to a point of sale transaction and procedure for the purposes of automated testing of the transaction and procedure. This invention records the details of the transaction and procedure by examining and saving to a database or file with the details of the procedural steps and transactional values as well as null values. The solutions provides pass or fail values after measuring the actual result to the expected result.

### STATEMENT RELATED TO FEDERALLY SPONSORED RESEARCH OR DEVELOPMENT

There is no federal sponsored research related to this inventions it was privately funded and sponsored.

### CROSS REFERENCE TO RELATED APPLICATIONS

There are no other related applications.

### INCORPORATION BY REFERENCE OF MATERIAL SUBMITTED ON COMPACT DISC

Not applicable.

### BACKGROUND OF THE INVENTION

(1) Field of Invention

This invention relates to automating the manual testing any transaction of a point of sale system. Before code can be released into production all UPC planned and expected pricing must be verified and quality controlled. He POSATT Point of Sale Automated testing technology stores the expected results and compares the actual results of POS without the need to test every item with its hardware controller such as a scan gun a check out register or a weight and measurement device.

Based on the details of the transaction in POSATT record mode, input data and responses are identified and then recorded as a test for later playback of the test or tests, in automated fashion. In test mode, the test is then identified as either pass if all recorded responses are received or fail if correct responses are not received for the transaction or procedure which compares the expected result to the actual result.

This invention helps retailers save millions of dollars by reducing the manual steps to test POS transactions and helps to release code into production by reducing the testing time line while also increasing the quality assurance process.

This invention simulates the hand keying of terminal operation procedures, saves input and responses of all point of sale devices for the testing of new procedure features and functionality in a point of sale system.

(2) Description of Related Art

The figures (art) that are attached to this filing are illustrations of how the POSATT invention interfaces to other hardware and software used for Point Of Sale.

### BRIEF SUMMARY OF THE INVENTION

The invention is a solution that is architected to simulate Point of Sale transactions that allows businesses to test the POS transactions in a defined and repeatable manner. This invention provides a software solution and method to test point of sale test transactions and validate that the correct point of sale transactions and discounts have passed quality assurance policy and standards and ready to be deployed to the production environment. The solution captures, for re-use, the systemic responses to a point of sale transaction and procedure for the purposes of automated testing of the transaction and procedure. This invention records the details of the transaction and procedure by examining and saving to a database or file with the details of the procedural steps and transactional values as well as null values. The solutions provides pass or fail values after measuring the actual result to the expected result. This solution a quality assurance solution meant to reduce cost of manual testing and improve testing timeline for moving code into production.

### DESCRIPTION OF THE DRAWINGS

FIG. 1: A diagram illustrating the relationship of the invention to the front end and back end Point Of Sale Technology.

FIG. 2: A diagram illustrating interrelationships between the principal communication paths and connectivity of the invention to Front and Back End Point for Point Of Sale Technology.

FIG. 3: A diagram illustrating the invention and its Test Creation Process.

FIG. 4: A diagram illustrating the invention and its Test Execution Process.

FIG. 5: A diagram illustrating the inventions details of the inventions hardware and software interface.

FIG. 7: A diagram illustrating the inventions API protocol for collecting the automated tests.

FIG. 8: A diagram illustrating the inventions graphical user interface for a retail device.

FIG. 9: A diagram illustrating the inventions graphical user interface for test type selection.

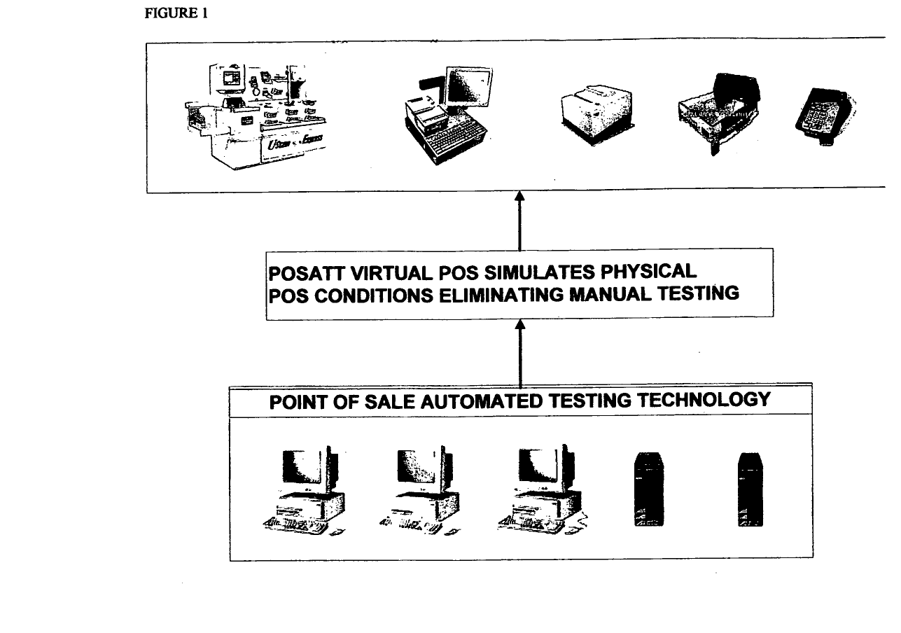

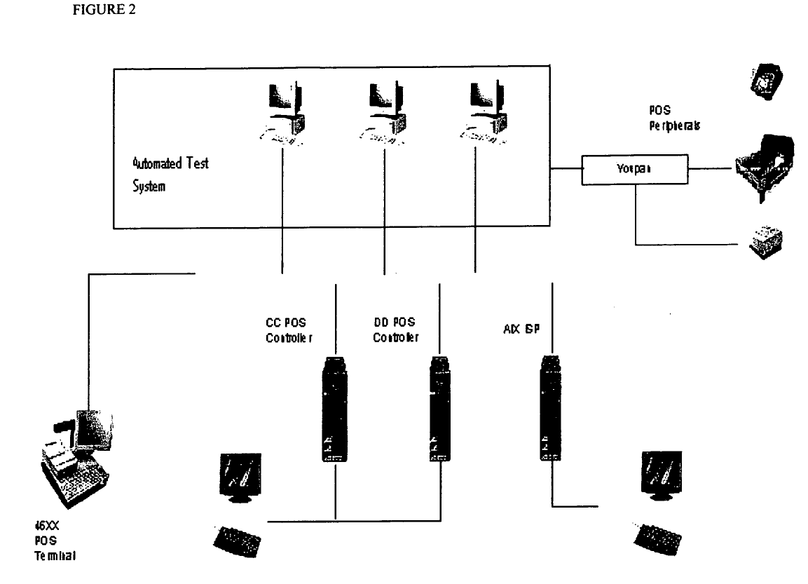

### DETAILED DESCRIPTION OF THE INVENTION

This invention is a software solution that will simulate hardware such as Scan Guns, Cash Registers, Weight and Measurement devices. The invention runs automated testing the transactions for planned and actual results. The invention ensures that the correct price or discount will be provided in production and the Point Of sale for the consumer. This invention is meant to automate the current process of manual testing whereby businesses must test each transaction on its original machine manually. This virtual POSATT Point Of Sale Automated Testing solution assumes that hardware is working as designed and therefore simulated the planned pricing and discounting which should be read by the hardware. This system reduces the manual effort of physically testing POS devices and provides a software solution that will simulate POS transactions. This invention stores in a database the production planned pricing or discounting. This solution runs thousands of simulated scans, checkouts or weights and measurements in a simulated environment as if they had been completed using the planned hardware. This invention then reports on and inconsistency in the form of a pas or fail response indicating the pricing or discounting are incorrectly loaded into the target production database that would be moved to production. This allows the retailer to make corrections to this data before the code is moved into production.

Today many companies are faced with testing their POS applications utilizing paper based scripts requiring a large expenditure of man-hours to complete. The testing of these scripts can take weeks just to get through the first pass of testing. As defects are identified and repaired, the manual test script must be started again from the beginning to ensure the code fix did not create new application defects. This adds significant costs and time to your overall project budget.

This invention supports a automated POS defined and repeatable process and technology. POSATT©—Point Of Sale Automated Testing Technology that has the capability to test (SA) Supermarket Application, (GSA) General Sales Application and Chain Drug/Pharmacy Sales. The POSATT© product eliminates the majority of manual testing processes for POS Terminal Applications.

With store labs configured to store check out lanes, POSATT© can ensure that the requirements meet the expected outcome. POSATT© will support a full set of baseline tests run overnight, against a full POS OS release or partial release, a (SA) Supermarket Application, (GSA) General Sales Application or Chain Drug/Pharmacy Sales Application release or partial release, or application enhancement releases. The pass or fail status of each test can be emailed to personnel of your designation. If application changes require a new baseline test to be established, POSATT© allows you to take the last successful test run and establish the new baseline test within minutes.

POSATT© is a powerful, easy to use tool that will help you streamline your POS testing process with improved quality, reduced cost, and a significant reduction of testing timeframes.

POSATT© is a POS behavior based testing approach. POSATT© will understand your POS unique behavior and alert you during testing when the expected behavior does not occur.

There are many device lists that are supported by POSATT© . The list has no limitations. The following are some of the device lists that are supported. (Scale, Customer Full Screen display, Customer 2×20 display, Keyboard 2×20 display, Cash Receipt Printers,Store Journal Printer (Electronic), Document Insert Printer, Cash Drawers, Tone, Scanner, Keyboard, Magnetic Stripe Reader, Keyboard, Magnetic Stripe Reader.

There are many motor keys lists that are supported by POSATT©. The list has no limitations. The following are some of the device lists that are supported.

| | |
|---|---|
| Tare | Item Lookup (2) |
| Food Stamp | Item Lookup (3) |
| Clear | Item Lookup (4) |
| Discount | Item Lookup (5) |
| Enter | Item Lookup (6) |
| FS/NO FS | Item Lookup (7) |
| Suspend/Retrieve | Item Lookup (8) |
| Check | Item Lookup (9) |
| Data Entry | Item Lookup (10) |
| Override | Misc. Tender Key 1 |
| Price | Misc. Tender Key 2 |
| Quantity | Misc. Tender Key 3 |
| No Sale | Mfr. Coupon Key |
| Total | Store Coupon Key |
| Void | Procedure Key 1 |
| Weight | Procedure Key 2 |
| Tax/No Tax | Procedure Key 3 |
| Verify | Procedure Key 4 |
| Cash | Procedure Key 5 |
| Deposit | |
| Refund Key | |
| Item Lookup (1) | |

This solution uses the following software configurations to produce the automated testing environment:

POSATT© Program Module Functionality Definitions

The modules identified below are the core functionality of the Point of Sale testing tool provided by the POSATT© (Point of Sale Automated Test Technology) software platform. A high level description of each program module is provided to identify basic functionality. Where an “*” (asterisk) is indicated in a module name it means that all files under the file structure are utilized. It must be noted that while this implementation is written in the JAVA programming language any other software language could be utilized to provide the same functionality. It is the process, identified by the high level descriptions, of the module interactions for which the patent is requested. The following program modules are used in the POSATT© test tool.

ACATLicense.java

This module is used to identify a valid POSATT© software license exists. It ensures the number of valid user licenses is not exceeded. This module calls the following POSATT© modules;
ACATException.java; DBUtilsForSetup.java; PropertyReader.java;
Logger.java; The following JRE (Java Runtime Environment) modules are called; java.sql.*.java;
java.util.Date.java;
   ACATMain.java

This module is the primary module of the POSATT© tool. It calls or passes control to the necessary modules that execute user and/or POSATT© systemic interactions. This module calls the following POSATT© modules; RTDisplayMgr.java; EnumMode.java; Logger.java; InteractiveSession.java; LearnSession.java; The following JRE (Java Runtime Environment) modules are called; java.util.HashMap.java;

ACATMqr.java

This module performs the roll of a traffic cop to ensure system or user interaction interactions are executed in the proper sequence and the proper modules are executed as required. This module calls the following POSATT© modules; RTDisplayMgr.java; RTDisplays.java; EnumMode.java; Logger.java; DbUtils.java; SessionRecorder.java; ACATLicense.java; ScriptObj.java; ScriptStep.java; InteractiveSession.java; LearnSession.java; RecordableSession.java; Session.java; PropertyReader.java; The following JRE (Java Runtime Environment) modules are called; java.sql.*.java; java.util.*.java; The following 4690 Point of Sale interface module is called; qvs. RPAMApp.java;

ACATProxyMar4Dummy.java

This module captures programmatic input or output requests and passes them to the ACATMgr.java module in testing mode. This module calls the following POSATT© modules; ScriptStep.java; TDSession.java; ; The following JRE (Java Runtime Environment) modules are called; java.io.PrintStream.java;

ACATProxyMar4TD.java

This module is utilized when a stored test run occurs from the stored test repository and captures programmatic requests or input and output and passes them into the ACATMgr.java module or the stored test repository. This module captures programmatic input or output requests and passes them to the ACATMgr.java module in testing mode. This module calls the following POSATT© modules; ScriptStep.java; TDSession.java;

DeviceBase.java

This module identifies Point of Sale devices (Keyboard, Scanner, Display, Printers, etc) and establishes the necessary communications protocols which is used by the ACATTerminal.java module to communicate through the interface to the Point of Sale system. This module calls the following POSATT© modules; RTDisplays.java; EnumMode.java; EnumOutputDevices.java;

TermLogger.java:

SessionRecorder.java; ScriptStep.java; The following 4690 Point of Sale interface module is called; qvs.RPAMTerminal.java;

ACATTerminal.java

This module is the terminal interface of the POSATT© tool. It connects with the 4690 Point of Sale Interface to establish the terminal interfaces requested by the user during setup. This module calls the following POSATT© modules; RTDisplays.java; EnumMode.java; Logger.java; TermLogger.java; SessionRecorder.java; DisplayEventHandler.java; EventHandler.java; SerialEventHandIer.java; CashDrawerlnput.java; KeyboardInputProcessor.java; ScaleInput.java; ScannerInput.java; ScriptRunner.java; ScriptStep.java; StepRunner.java; PropertyReader.java; ; The following JRE (Java Runtime Environment) modules are called; java.io.PrintStream.java; The following 4690 Point of Sale interface module is called; qvs.RPAMDevices.*.java; qvs.RPAMGlobals.java; qvs.RPAMTerminal.java;

MgrInitObj.java

This module initializes the POSATT© devices (RTDisp_KeyboardInputjava=Keyboard, RTDisp_Scanner.java=Scanner, RTDisplays.java=Display, RTDisp_Printer.java=Printers, etc), corresponding to the Point of Sale devices and establishes the systemic connectivity between the two systems. This module calls the following POSATT© modules; RTDisplayMgr.java; EnumMode.java; Logger.java; PropertyReader.java;; The following JRE (Java Runtime Environment) modules are called; java.util.HashMap.java;

UserSetup.java

This module determines and stores how the POSATT© tool is operating. Interactive mode, Learning mode, or in Testing mode.

RTDisp 2×20.java

This module allows the creation of a 2 by 20 character display on the POSATT©, terminal/register window. The following JRE (Java Runtime Environment) modules are called; java.awt.Font.java; javax.swing.*.java; javax.swing.border.EtchedBorderjava;; javax.swing.border.TitledBorder.java;

RTDisp CashDrawer.java

This module allows the creation of a Cash Drawer character display on the POSATT© terminal/register window. The following JRE (Java Runtime Environment) modules are called;
java.awt. Font.java; javax.swing.Box.java; javax.swing.Jlabel.java;
javax.swing.border.EtchedBorder.java; javax.swing.border.TitledBorder.java;
   RTDisp KeyboardInput.java

This module allows the creation of a Keyboard character display on the POSATT© terminal/register window. This module calls the following POSATT© modules; KeyboardInputProcessor.java; ScriptStep.java; The following JRE (Java Runtime Environment) modules are called;
java.awt.Dimension.java; java.awt.Font.java; java.awt.event.ActionEvent.java;
java.awt.event.ActionListener.java; java.util.HashMap.java; javax.swing.*.java;
javax.swing.border.EtchedBorder.java; javax.swing.border.TitledBorder.java;
   RTDisp Printer.java

This module allows the creation of a Receipt Printer character display, Journal Printer character display, and a Check Printer character display on the POSATT© terminal/register window.; The following JRE (Java Runtime Environment) modules are called; javax.swing.JscrollPane.java;
javax.swing.JtextArea.java; javax.swing.border.EtchedBorder.java;
javax.swing.border.TitledBorder.java;
   RTDisp_Scanner.java

This module allows the creation of a Scanner character display on the POSATT© terminal/register window. The following JRE (Java Runtime Environment) modules are called; java.awt.Font.java; javax.swing.Jlabel.java; javax.swing.border.EtchedBorder.java; javax.swing.border.TitledBorder.java;

RTDisplayMgr.java

This module controls output to either the 2 by 20 displays (one each for Customer and Terminal Operator) or a Full Screen terminal/register window. This module calls the following POSATT© modules; ACATTerminal.java; The following JRE (Java Runtime Environment) modules are called;
java.applet.Applet.java; java.awt.*.java; java.io.PrintStream.java; java.util.*.java;
javax.swing.Jframe.java; javax.swing.JscrollPane.java;
   RTDisplays.java

This module allows the creation of a Full Screen character display on the POSATT© terminal/register window. This module calls the following POSATT© □ modules; ACATTerminal.java; Constants.java; The following JRE (Java Runtime Environment) modules are called; java.awt.*.java; java.awt.event.ActionEvent.java; java.awt.event.ActionListener.java; javax.swing.*.java;

Constants.java

This module identifies the interface names Keyboard, Scanner, 2×20 Display, Full Screen Display, Journal Printer, Check Printer, Receipt Printer, Scale, MSR=Magnetic Stripe Reader, Cash Drawers, etc., as well as the mode interfaces of Interactive, Learning or Testing. EnumDeviceStates.java

This module helps determine the on or off state of the various interface devices.

EnumInputDevices.java

This module initializes the input mode of device types.

EnumMode.java

This module initializes the POSATT© Interactive, Learning, or Testing mode.

EnumOutputDevices.java

This module initializes the output mode of the device types.

Logger.java

This module establishes the event log file. This module calls the following POSATT© modules; Utils.java; The following JRE (Java Runtime Environment) modules are called; java.io.*.java; java.util. Date.java;

TD DummyReader.java

This module holds results of the testing mode execution which is then parsed by the TD_ResultReader.java module and written to the Log file. This module calls the following POSATT© modules; DbUtils.java; PropertyReader.java; The following JRE (Java Runtime Environment) modules are called; java.sql.Connection.java; java.util.HashMap.java; java.util.Properties.java;

TD ResultReader.java

This module writes testing mode results to the Log file. This module calls the following POSATT© modules; DbUtils.java; D_DeviceResultObj.java; ACATException.java; PropertyReader.java; The following JRE (Java Runtime Environment) modules are called; java.io.*.java; java.sql.*.java; java.util.*.java;

TermLogger.java

This module writes POSATT© terminal/register events to the log file. This module calls the following POSATT© modules; ACATTerminal.java; The following JRE (Java Runtime Environment) modules are called; java.io.PrintStream.java; java.util.HashMap.java; DbUtils.java

This module is utilized to write information to the database or file system. This module calls the following POSATT© modules; Logger.java; The following JRE (Java Runtime Environment) modules are called; java.io.PrintStream.java; java.sql.*.java; java.text.SimpleDateFormat.java; java.util.*.java;

SessionRecorder.java

This module is used when in Learning or Testing mode to capture and store POSATT© terminal/register input and output events of the session. This module calls the following POSATT© modules; ACATMgr.java; MgrInitObj.java; common.*.java; ACATException.java; ScriptStep.java; RecordableSession.java; The following JRE (Java Runtime Environment) modules are called;
java.io.*.java; java.sql.*.java; java.util.*.java;
   TD DeviceResultObj.java

This module is a driver utilized to capture and store input and output when in the Testing mode. This module is used by TD_ResultReader_TEST.java, and TD_TestDirector_TEST.java modules. The following JRE (Java Runtime Environment) modules are called; java.util.ArrayList.java;
java.util.Collections.java;
   TD NoSaleInOrder.java

This module is utilized to capture and store input and output when in the Learning mode for the specific test No Sale In Order. This module calls the following POSATT© modules; ACATMgr.java;
ACATProxyMgr4TD.java; TD_ResultReader.java; ScriptStep.java;
TDSession.java; The following JRE (Java Runtime Environment) modules are called; java.io.*.java; java.util.*.java;
   TD ResultReader TEST.java

This module is utilized to capture and store input and output when in the Testing mode. This module calls the following POSATT© modules; TD_ResultReader.java; The following JRE (Java Runtime Environment) modules are called; java.io.*.java; java.util.*.java;

TD TestDirector TEST.java

This module is utilized to control individual test step execution when in the Testing mode. This module calls the following POSATT© modules; ACATMgr.java; ACATProxyMgr4TD.java; TD_ResultReader.java; ScriptStep.java; TDSession.java; The following JRE (Java Runtime Environment) modules are called; java.io.*.java; java.util.*.java;

ACATException.java

This module captures errors to be sent to the log file. This module calls the following POSATT© module logger.java. The following JRE (Java Runtime Environment) modules are called;
java.io.CharArrayWriter.java; java.io.PrintWriter.java;
   DisplayEventHandler.java

This module is utilized to process the POSATT© terminal/register display and Point of Sale display interface program. This module calls the following POSATT© modules ACATTerminal.java; DeviceBase.java; .RTDisplays.java; EnumOutputDevices.java. The following Point of Sale interface modules are called; DisplayEventListener.java; RPAMEvents.DisplayEvent.java; RPAMEvents.DisplayExEvent.java;

EventHandler.java

This module is utilized to process the POSATT© terminal/register devices and Point of Sale interface device programs. This module calls the following POSATT© modules; ACATTerminal.java; RTDisplays.java; EnumDeviceStates.java; EnumOutputDevices.java; lnputDeviceUser.java; ScaleInput.java; Utils.java. The following JRE (Java Runtime Environment) modules are called; java.io.PrintStream.java. The following Point of Sale interface modules are called; RPAMDevices.*.java; RPAMEventListener.java; RPAMEvents.*.java; RPAMTerminal.java;

SerialEventHandler.java

This module is utilized to process the POSATT© serial devices and Point of Sale interface serial device programs. This module calls the following POSATT© modules; ACATTerminal.java; DeviceBase.java; Utils.java. The following Point of Sale interface modules are called;
RPAMDevices.POSSerialDevice.java; RPAMEvents.*.java; RPAMTerminal.java;
SerialEventListener.java;
   CashDrawerInput.java

This module is utilized to process the POSATT© terminal/register cash drawer devices and Point of Sale cash drawer interface device programs. This module calls the following POSATT© modules;
ACATTerminal.java; DeviceBase.java; RTDisplays.java; EnumInputDevices.java;
ACATException.java; ScriptStep.java; The following Point of Sale interface modules are called;
RPAMDevices.POSCashDrawer.java; RPAMTerminal.java;
   FileOperations.java

This module is utilized to process the POSATT© terminal/register file operations and Point of Sale interface keyed file operations programs. This module calls the following POSATT© modules; Logger.java; Utils.java; The following Point of Sale interface modules are called;
RPAM Devices. POSFile .java; RPAM Devices. POSKeyedFile.java;
   InputDeviceUser.java

This module is utilized to initialize the POSATT© terminal/register user input devices Keyboard, Scale, Scanner, and Cash Drawers in any mode selected. This module calls the following POSATT© modules; ACATTerminal.java; DeviceBase.java;

KeyboardInputProcessor.java

This module accepts and interprets the POSATT© terminal/register user input keyboard commands in any mode selected and sends them to the Point of Sale Terminal interface programs for further processing. This module calls the following POSATT© modules; ACATTerminal.java; DeviceBase java; EnumInputDevices.java; EnumMode.java; Session Recorder.java; ScriptStep java. The following JRE (Java Runtime Environment) modules are called; java.io.PrintStream.java; The following Point of Sale interface modules are called; RPAMDevices.*.java; RPAMTerminal.java;

ScaleInput.java

This module accepts and interprets the POSATT© terminal/register user input scale commands in any mode selected and sends them to the Point of Sale Terminal interface programs for further processing. This module calls the following POSATT© modules; ACATTerminal.java; DeviceBase.java; ScriptStep.java; The following JRE (Java Runtime Environment) modules are called; java.io.PrintStream.java; The following Point of Sale interface modules are called; POSScalejava; RPAMTerminal.java;

ScannerInput.java

This module accepts and interprets the POSATT© terminal/register user input scanner commands in any mode selected and sends them to the Point of Sale Terminal interface programs for further processing. This module calls the following POSATT© modules; ACATTerminal.java; DeviceBase.java; ScriptStep.java. The following JRE (Java Runtime Environment) modules are called; java.io.PrintStream.java; The following Point of Sale interface modules are called; POSScanner.java; RPAMTerminal.java;

ScriptObj.java

This module is utilized to initialize the POSATT© Automatic Test mode interfaces and files for input processing and output processing.

ScriptRunner.java

This module is utilized to initialize the POSATT© Automatic Script Test mode systems. This module calls the following POSATT© modules; ACATTerminal.java; EnumInputDevices.java; DbUtils.java; ACATException.java; InputDeviceUser.java; KeyboardInputProcessor.java; PropertyReader.java. The following JRE (Java Runtime Environment) modules are called; java.io.PrintStream.java; java.sql.*.java; java.util.TreeMap.java;

ScriptStep.java

This module is utilized to initialize the POSATT© Automatic Script Test mode appropriate input device and to receive output information from the device. This module calls the following POSATT© modules; EnumInputDevices.java;

StepRunner.java

This module is utilized to record execute the POSATT© Automatic Script Test mode commands and to receive and record output information from the POSATT© test tool. This module calls the following POSATT© modules; ACATTerminal.java; RTDisplays.java; common.*.java; SessionRecorder.java; ACATException.java; Input.*.java;

InteractiveSession.java

This module is utilized to establish a session that will only interact with the 4690 Point of Sale. It does not record keystrokes or interact with the either the learn session or test sessions of the POSATT© system. This module calls the following POSATT© modules; ACAT.session.java

LearnSession.java

This module is utilized to establish a recording session that will interact with the 4690 Point of Sale and the POSATT© database and file system to record keystroke and 4690 Point of Sale response data. It records keystrokes and can interact with the test sessions of the POSATT© system. This module calls the following POSATT© modules; ACAT.session.java

RecordableSession.java

This module is utilized to establish a recording session that will interact with the 4690 Point of Sale and the POSATT© database and file system to record keystroke and 4690 Point of Sale response data. It records keystrokes and can interact with the either the test sessions of the POSATT© system. This module calls the following POSATT© modules; ACAT.session.java

Session.java

This module is the high level initiator of a interactive, learning, Recording, or Testing session. This module calls the following POSATT© modules; EnumMode.java; The following JRE (Java Runtime Environment) modules are called; java.util.Date.java;

TDSession.java

This module is utilized to establish and run a testing session that will interact with the 4690 Point of Sale and the POSATT© database and file system to record keystroke and 4690 Point of Sale response data the information is then passed to the stored test database and file system where pass and fail data is created for each step of the test This module calls the following POSATT© modules;

ACAT.session .java

ACATSetup.java

This module is utilized to establish the primary user interface where either a learn session or interactive session is requested by the user. It can run a learn session that will interact with the 4690 Point of Sale and the POSATT© database and file system to record keystroke and 4690 Point of Sale response data. It can then send all learned input and 4690 Point of Sale output to the stored test database and file system. This module calls the following POSATT© modules; ACATMgr.java; ACATLicense.java; RTDisplayMgr.java; EnumMode.java; Logger.java; ACATException.java; InteractiveSession.java; LearnSession.java; PropertyReader.java; The following JRE (Java Runtime Environment) modules are called; java.awt.*.java; javax.swing.Jframe.java; javax.swing.JmenuBar.java;

Constants.java

This module is used to establish the primary user interface windows and menu data selections of ACATSetup.java. The following JRE (Java Runtime Environment) modules are called; java.awt.Color.java; java.awt.Font.java;

DBUtilsForSetup.java

This module is used to establish the primary user interface database and file system connectivity ACATSetup.java. This module calls the following POSATT© [ modules; Logger.java; ACATException.java; PropertyReader.java; The following JRE (Java Runtime Environment) modules are called; java.sql.*.java; java.util.ArrayList.java; java.util.Properties.java;

DropDownDialogs.java

This module is used to establish the primary user interface drop down menu's data selections of ACATSetup.java. The following JRE (Java Runtime Environment) modules are called; java.awt.*.java ; java.awt.event.ActionEvent.java; java.awt.event.ActionListener.java; java.io.PrintStream.java; javax.swing.*.java; javax.swing.event.ListSelectionEvent.java; javax.swing.event. ListSelectionListener.java;

InfoPanel.java

This module is used to establish the primary user interface mode menu's data selections of ACATSetup.java. This module calls the following POSATT© modules; EnumMode.java; The following JRE (Java Runtime Environment) modules are called; java.awt.*.java; javax.swing.*.java;

LogonDialog.java

This module is used to establish the primary user logon window interface of ACATSetup.java. The following JRE (Java Runtime Environment) modules are called; java.awt.*.java; java.awt.event.ActionEvent.java; java.awt.event.ActionListener.java; javax.swing.*.java;

ModeMenu.java

This module is used to establish the primary user interface mode selection window of ACATSetup.java. This module calls the following POSATT© modules;EnumMode.java; The following JRE (Java Runtime Environment) modules are called; java.awt.event.ActionEvent.java; java.awt.event.ActionListener.java; javax.swing.*.java;

SessionMenu.java

This module is used to establish the primary user interface session (learn or interactive) selection window and data of ACATSetup.java. This module calls the following POSATT© modules;

EnumMode.java; The following JRE (Java Runtime Environment) modules are called; java.awt.event.ActionEvent.java; java.awt.event.ActionListener.java; java.io.PrintStream.java; javax.swing.*.java;

SetupMenu.java

This module is used to establish for user selection the primary user interface session (learn or interactive) selection windows, drop down menu's and constant window data of ACATSetup.java.; The following JRE (Java Runtime Environment) modules are called; java.awt.event.ActionEvent.java; java.awt.event.ActionListener.java; java.io.PrintStream.java; javax.swing.*.java;

TermNumsDialog.java

This module is used to establish and list for user selection the number of 4690 Point of Sale terminal interfaces the user would like to have during a session. The following JRE (Java Runtime Environment) modules are called; java.awt.*.java; java.awt.event.*.java; java.io.PrintStream.java; java.util.*.java; javax.swing.*.java;

PropertyReader.java

This module reads the POSATT© properties file and establishes the necessary system connections to assist in setup of the user session that is requested. This module calls the following POSATT© modules; Logger.java; ACATException.java; The following JRE (Java Runtime Environment) modules are called; java.io.*.java; java.util.Properties.java;

Utils.java

This module provides data formating conversions of input and output data of the POSATT© system for the .JRE (Java Runtime Environment). The following JRE (Java Runtime Environment) modules are called; java.io.*.java; java.text.SimpleDateFormat.java;
java.util.*.java;
The POSATT database.

The database or file includes but are not limited to, the name of the test, the input transaction or transactions associated with the test, the output responses associated with the input transaction or transactions, the date the test was run, and a pass or fail indicator. When a user selects a test to be recorded by the apparatus, the apparatus executes an executable file that provides; 1.) an input area for scanned or keyed product items or terminal operations procedures, as well as, 2.) areas for providing periphery devices informational output display for POS terminal periphery devices that receive output information in response to the input presented to a point of sale terminal. Periphery devices are, but not limited to, a Customer 2×20 Display, Keyboard, Scanner, Serial Devices, Magnetic Stripe Readers, Printers, Barcode Reader, etc.

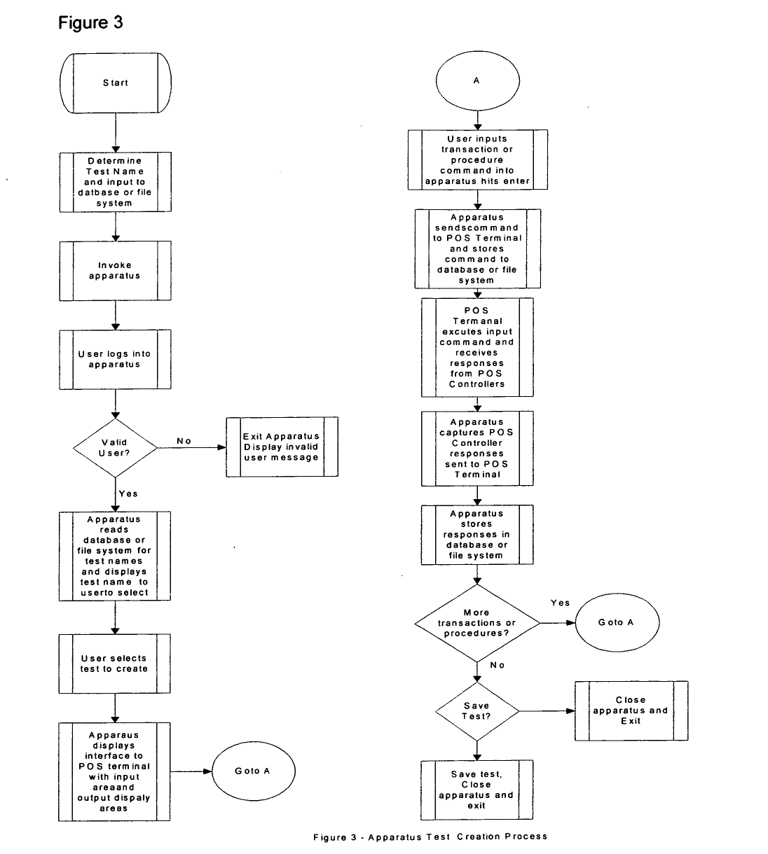

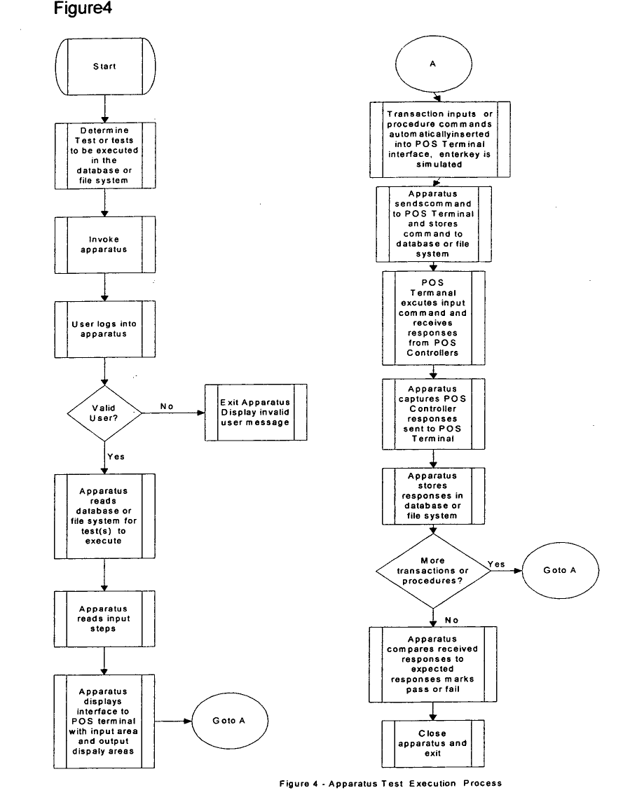

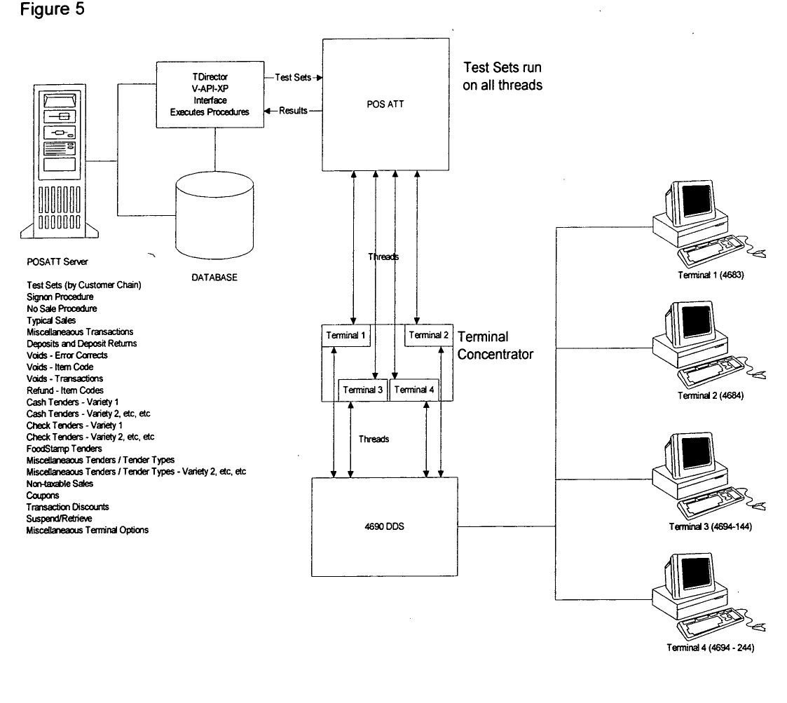

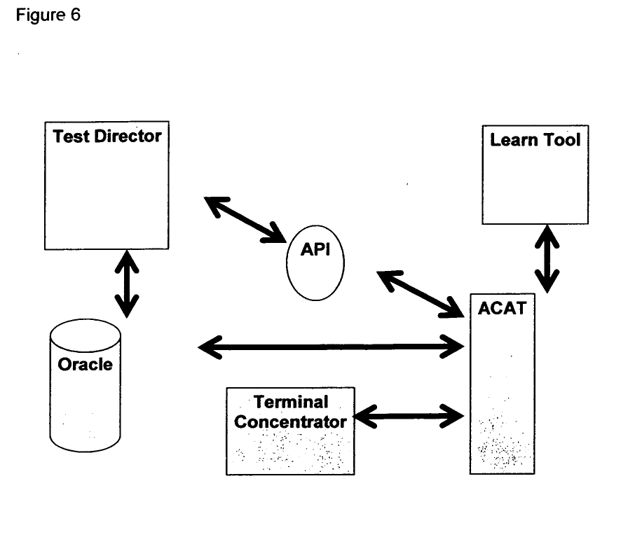

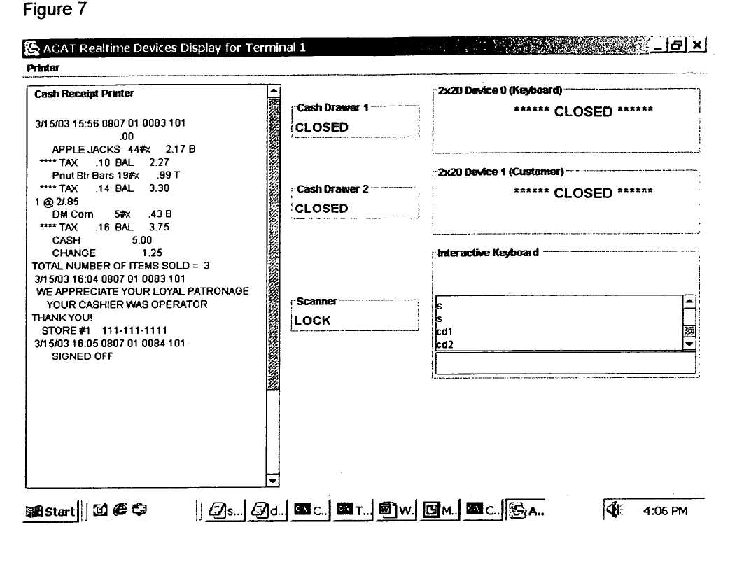

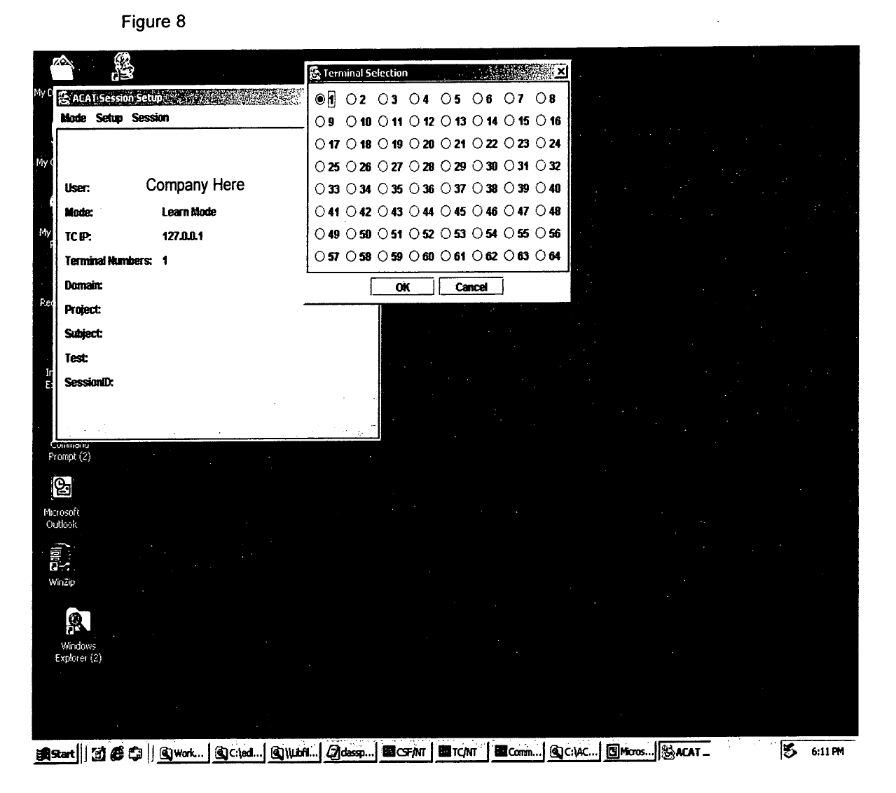

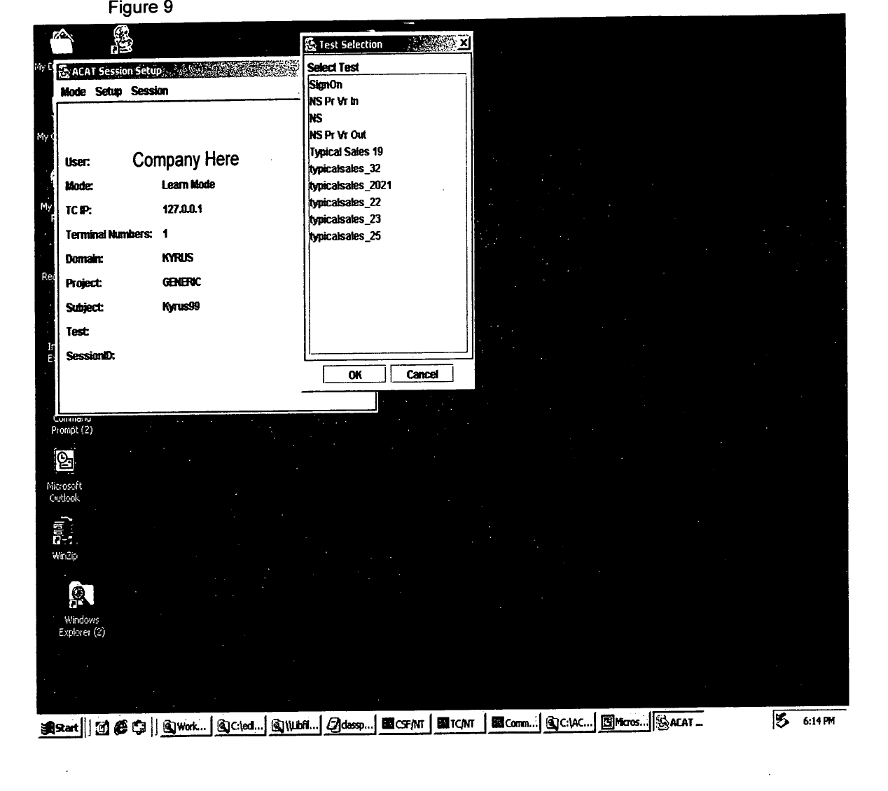

In the process of test execution, the files or database are used as illustrated in simplified form in FIG. 2. The database or file is accessed by the user, the test name or series of tests are selected, the tests can be set to run immediately or a time may be entered for the test to execute when the time identified is reached by the system clock. On test execution the apparatus, 1.) executes an executable file, 2.) the apparatus automatically inputs the transaction or transactions associated with the test, 3.) the apparatus records the output responses to the periphery devices associated with the input transaction or transactions, 4.) the apparatus stores the date and time the test was run, and 5.) the apparatus stores a pass or fail indicator on the database or file system.

The date/time of the transaction are recorded in the form MMDDYYYY: hhmmss, where MM is the month, DD the day of the month, YYYY is the year, and hh is hour of the day, mm is the minute of the day and ss are seconds of the day.

1. The Point Of Sale Automation Testing invention can reduce the manual testing process for Point of Sale and improve productivity and quality of Point Of Sale Quality Assurance Testing.

2. The Point Of Sale Automated Testing invention can simulate hardware point of sale systems such as scan guns, registers and weights and measures.

3. The Point Of Sale Automated Testing invention can store the planned retail transactions and compare the planned to actual results in the form of reports that will show pass fail status.

4. The Point Of Sale Automated Testing invention can initiate a point of sale transaction or terminal operation procedure and record for playback the point of sale transaction details or terminal operations procedures.

5. The Point Of Sale Automated Testing invention can run automatic playback of point of sale transaction(s) or terminal operations procedures.

6. The Point Of Sale Automated Testing invention can automate the pass or fail identification of terminal responses.
